(19) United States
(12) Patent Application Publication
(10) Pub. No.: US 2005/0177738 A1
(43) Pub. Date: Aug. 11, 2005

(54) Watermark embedding and retrieval

(75) Inventors: Minne Van Der Veen, Eindhoven (NL); Alphons Antonius Maria Lambertus Bruekers, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., NL-5621 BA Eindhoven (NL)

(21) Appl. No.: 10/513,746

(22) PCT Filed: Apr. 15, 2003
(86) PCT No.: PCT/IB03/01524

(30) Foreign Application Priority Data
May 10, 2002 (EP) 02076848.7

(51) Int. Cl. H04L 9/32

(52) U.S. Cl. 713/189

(57) ABSTRACT

Fingerprinting is a technique to identify multimedia signals by extracting robust perceptual features of the signal contents and searching the extracted features in a database where titles, artists, etc. are stored. Watermarking is a technique of embedding payload data in a signal in an unobtrusive manner. The invention combines both techniques. A fingerprint (M(i)) is extracted (1) from a host signal (x) and stored in a database (5). A watermark (w(i)) is embedded (2) in the host signal by modifying (21) the signal, such that the fingerprint (M′(i)) of the modified signal (x′) differs slightly from the original fingerprint. The difference is so small that the database considers them to be similar. At the receiver end, the fingerprint is extracted (3) from the watermarked signal and applied to the database, which responds by returning the original fingerprint of the signal. The embedded watermark is retrieved by subtracting (4) the original fingerprint supplied by the database from the fingerprint extracted from the host signal.

### FIELD OF THE INVENTION

The invention relates to a method and arrangement for embedding a watermark in an information host signal. The invention also relates to a method and arrangement for retrieving the embedded watermark.

### BACKGROUND OF THE INVENTION

A prior-art method of embedding and retrieving a watermark is disclosed in Khalid A. Kaabneh and Abdou Youssef “Muteness-Based Audio Watermarking Technique”, presented at the 2001 IEEE Conference on distributed computing systems workshop, pp. 379-383. In this prior-art document, a sequence of periods of silence (mute periods) that occur in an audio signal are extracted from the host audio signal. The watermark is embedded by slightly modifying said mute periods, such that the watermarked signal is not perceptually different for the human auditory system. The watermark is retrieved by extracting the mute periods from a watermarked copy, and subtracting the original mute periods therefrom. The difference between both is the watermark to be retrieved.

The prior-art document discloses that it is sufficient for the watermark detector to have the original lengths of the mute periods available. The original signal itself is not required. The document does not disclose how the original lengths of mute periods of a watermarked signal are obtained. This is a problem in practical situations where the host signal is often unknown.

### OBJECT AND SUMMARY OF THE INVENTION

It is an object of the invention to provide a solution for the above-mentioned problem of the prior-art watermark embedding and retrieving method.

To this end, the invention provides a method and arrangement for embedding a watermark in a host signal, the method comprising the steps of extracting from the host signal an original fingerprint representing a perceptual feature of the host signal, storing the original fingerprint of the host signal in a database along with original fingerprints of further host signals, and modifying the host signal, such that the fingerprint is modified in accordance with the watermark to be embedded.

A fingerprint, often also referred to as signature or hash, is the result of a function that maps perceptual features of a signal to a binary sequence. Unlike cryptographic hashes that are extremely fragile (flipping a single bit of the source data will generally result in a completely different hash), fingerprints are herein understood to be robust. That is, if source signals are perceptually similar, then the corresponding fingerprints are also very similar. Fingerprints are therefore used to identify audiovisual contents. An example of such fingerprints and use thereof is disclosed in Jaap Haitsma, Ton Kalker and Job Oostveen: “Robust Audio Hashing for Content Identification”, published at the Content-Based Multimedia Indexing (CBMI) 2001. Conference in Brescia, Italy.

The invention is based on the recognition that the perceptual features being modified to represent the watermark as taught by the prior-art constitutes a fingerprint. The invention exploits the insight that the fingerprint of the watermarked signal and the original fingerprint will only slightly differ, whereas fingerprints of perceptually different host signals will differ substantially. It is thus achieved with the invention that the watermarked signal can be identified by virtue of its original fingerprint stored in the database.

The corresponding method of retrieving a watermark embedded in a watermarked host signal comprises the steps of extracting from the watermarked host signal a fingerprint representing a perceptual feature of the watermarked host signal, searching, in a database in which original fingerprints of a plurality of host signals are stored, an original fingerprint which substantially matches the extracted fingerprint, and determining the difference between the original fingerprint found in the database and said extracted fingerprint, where said difference represents the watermark to be retrieved.

An embodiment of the watermark embedding method further comprises the steps of extracting from said host signal an identification of the host signal, and storing said identification in the database to identify the location of the corresponding original fingerprint in the database. Such an additional identification makes the process of searching the original fingerprint in the database easier, faster and more univocal.

In an advantageous embodiment, the identification is a further fingerprint representing a further perceptual feature of the host signal. With such an embodiment, one fingerprint conveys the watermark whereas the other fingerprint is used to identify the location of the original fingerprint in the database. Different fingerprint schemes can now be chosen that are optimal for their respective purposes.

These and other aspects of the invention are apparent from and will be elucidated with reference to the embodiment described hereinafter.

### BRIEF DESCRIPTION OF THE DRAWINGS

FIG. 1 is a schematic diagram of a system comprising a watermark embedding arrangement and a watermark retrieving arrangement according to the invention.

FIG. 2 is a schematic diagram of a further embodiment of the system according to the invention.

### DESCRIPTION OF EMBODIMENTS

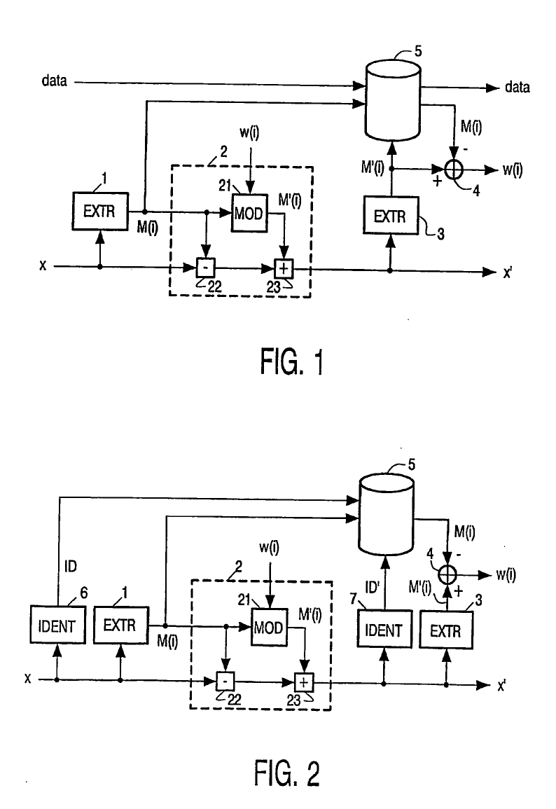

FIG. 1 is a schematic diagram of a system comprising a watermark embedding arrangement and a watermark retrieving arrangement according to the invention. The watermark embedding arrangement comprises a fingerprint extracting circuit 1 and a watermark embedding module 2. The watermark retrieving arrangement comprises a fingerprint extracting circuit 3 and a watermark retrieving module 4. Both arrangements have access to a database 5.

The watermark embedding arrangement receives a multimedia host signal x. It will be assumed here that the multimedia signal x is an audio signal, but it will be appreciated that the multimedia signal may also be a video, image, or other type of signal. The signal x is applied to the fingerprint extraction circuit 1, which analyses the audio signal for occurrences of periods of silence in accordance with the teaching of Kaabneh et al. referenced herein before. The output of the extraction circuit constitutes a fingerprint in the form of a sequence of mute periods M(i). The fingerprint M(i) extracted from the original host signal x will further be referred to as original fingerprint. The original fingerprint M(i) is stored in the database 5, possibly along with other data such as title of the song, artist, dates of creation, etc. A plurality of fingerprints extracted from a plurality of different songs are stored in the database in this manner.

The audio signal x is also applied to the watermark embedding module 2. In this module, a watermark is embedded which is applied to the module in the form of a sequence of watermark signal samples w(i). The watermark embedding module 2 modifies the signal x in such a manner that the mute periods M(i) are slightly lengthened or shortened in accordance with the watermark. This operation can be typically expressed as:
M′(i)=M(i)+w(i) (1)

In the Figure, the watermark embedding operation is schematically illustrated as being carried out by a modification circuit 21, a separation circuit 22 and an insertion circuit 23. The modification circuit 21 modifies the original mute periods M(i) into modified mute periods M′(i) in accordance with respective samples w(i) of the watermark. The watermark is embedded by first separating the original mute periods from the signal and subsequently inserting the new mute periods M′(i) into the signal.

The watermark retrieving arrangement receives the watermarked signal x′. The watermarked signal is applied to a fingerprint extracting circuit 3, which is similar to the fingerprint extraction circuit 1 of the embedding arrangement. Accordingly, the mute periods M′(i) are extracted from the watermarked signal x′. The sequence of mute periods M′(i) is applied to the database 5 for matching with the plurality of original fingerprints stored in the database. Since the difference between the mute periods M′(i) of the watermarked signal x′ and the original fingerprint M(i) of the original signal x is small, the most resembling sequence of mute periods found in the database may be assumed to be the one that corresponds to the original signal x. The stored fingerprints of other signals will generally be substantially different.

The database 5 outputs the original sequence of mute periods M′(i) to the watermark retrieving module 4. Herein, the original mute periods M(i) as found in the database are compared with the extracted mute periods M′(i) to retrieve the watermark. In conformity with equation (1), this operation can be typically expressed as:
w(i)=M′(i)−M(i) (2)
Additional data associated with the song, such as title of the song, artist, dates of creation, etc. can also be retrieved from the database.

In the example described above, the fingerprint is represented by the mute periods of an audio signal. Another example of a robust perceptual property that can constitute the fingerprint is a binary representation of the energy differences of several frequency bands of the audio signal as disclosed in Haitsma et al. referenced hereinbefore. The Haitsma et al. reference also provides a detailed description of a practical matching strategy to find the most resembling fingerprint in the database. For video and image applications, a sequence of mean luminance differences between image blocks may constitute the fingerprint.

FIG. 2 is a schematic diagram of a further embodiment of the system. The same reference numerals are used in this Figure to denote the same elements as in FIG. 1. The embedding arrangement now comprises an identification circuit 6 which generates an identification signal ID to identify the original host signal x. The identification signal ID is stored in the database 5 along with the fingerprint M(i) with which it is associated. The retrieving arrangement comprises an identical or similar identification circuit 7, which generates an identification signal ID′ to identify the watermarked signal x′. In this embodiment, the identification signal ID′ is used to search in the database the stored fingerprint M(i) of original signal x.

If the original signal x is a digital computer file (e.g. an mp3 song) which includes metadata such as an ID tag identifying the file, then the identification signal ID may take the form of (a part of) said ID tag. Assuming that the ID tag is not affected by the watermark embedding process, the identification signal ID′ derived from the watermarked signal is exactly the same. The fairly complicated process of fingerprint matching is now reduced to a simple look-up operation. The original fingerprint M(i) of the original signal can thus easily be found in the database.

If the original signal x does not have such a tag, the identification signal ID can be another fingerprint of the signal, now being extracted on the basis of a different robust perceptual feature of the contents. In this case, the identification circuits 6 and 7 are further fingerprint extraction circuits. This embodiment allows the fingerprint extraction circuits 1 and 3 for conveying the watermark, on the one hand, and identification circuits 6 and 7 for signal identification, on the other hand, to be optimized for their respective purposes.

It should be noted that the location of the database 5 is not relevant to the invention. The database may be located at the embedding arrangement end, the retrieving arrangement end, or remote from both. Where necessary, networks such as the Internet, may be used to apply fingerprints to or retrieve fingerprints from the database.

The invention can be summarized as follows. Fingerprinting is a technique to identify multimedia signals by extracting robust perceptual features of the signal contents and searching the extracted features in a database where titles, artists, etc. are stored. Watermarking is a technique of embedding payload data in a signal in an unobtrusive manner. The invention combines both techniques. A fingerprint (M(i)) is extracted (1) from a host signal (x) and stored in a database (5). A watermark (w(i)) is embedded (2) in the host signal by modifying (21) the signal, such that the fingerprint (M′(i)) of the modified signal (x′) differs slightly from the original fingerprint. The difference is so small that the database considers them to be similar. At the receiver end, the fingerprint is extracted (3) from the watermarked signal and applied to the database, which responds by returning the original fingerprint of the signal. The embedded watermark is retrieved by subtracting (4) the original fingerprint supplied by the database from the fingerprint extracted from the host signal.

1. A method of embedding a watermark in a host signal, comprising the steps of:
extracting from the host signal an original fingerprint representing a perceptual feature of the host signal,
storing the original fingerprint of the host signal in a database along with original fingerprints of further host signals, and
modifying the host signal, such that the fingerprint is modified in accordance with the watermark to be embedded.

2. A method as claimed in claim 1, further comprising the steps of extracting from said host signal an identification of the host signal, and storing said identification in the database to identify the location of the corresponding original fingerprint in the database.

3. A method as claimed in claim 2, wherein said identification is a further fingerprint representing a further perceptual feature of the host signal.

4. A method of retrieving a watermark embedded in a watermarked host signal, comprising the steps of:
extracting from the watermarked host signal a fingerprint representing a perceptual feature of the watermarked host signal,
searching, in a database in which original fingerprints of a plurality of host signals are stored, an original fingerprint which substantially matches the extracted fingerprint, and
determining the difference between the original fingerprint found in the database and said extracted fingerprint, where said difference represents the watermark to be retrieved.

5. A method as claimed in claim 4, wherein for each plurality of host signals an identification is stored in the database to identify the location of the corresponding original fingerprint, the method further comprising the steps of extracting from the watermarked host signal an identification of the watermarked host signal, and using said identification to identify in the database the location of the corresponding original fingerprint.

6. A method as claimed in claim 5, wherein said identification is a further fingerprint representing a further perceptual feature of the watermarked host signal.

7. An arrangement for embedding a watermark in a host signal (x), comprising:
means (1) for extracting from the host signal an original fingerprint (M(i)) representing a perceptual feature of the host signal, and storing the original fingerprint of the host signal in a database (5) along with original fingerprints of further host signals, and
means (2) for modifying the host signal, such that the fingerprint is modified in accordance with the watermark (w(i)) to be embedded.

8. An arrangement for retrieving a watermark embedded in a watermarked host signal (x′), comprising:
means (3) for extracting from the watermarked host signal a fingerprint (M′(i)) representing a perceptual feature of the watermarked host signal,
means (5) for searching in a database in which original fingerprints of a plurality of host signals are stored, an original fingerprint (M(i)) which substantially matches the extracted fingerprint, and
means (4) for determining the difference between the original fingerprint found in the database and said extracted fingerprint, where said difference represents the watermark (w(i)) to be retrieved.
